(19) United States
(12) Patent Application Publication
(10) Pub. No.: US 2026/0091438 A1
(43) Pub. Date: Apr. 2, 2026

(54) METHOD AND SYSTEM FOR CONTROLLING MACHINING ACCURACY OF WIRE ELECTROCHEMICAL TRIMMING FOR COMPLEX PROFILE

(71) Applicant: NANJING UNIVERSITY OF AERONAUTICS AND ASTRONAUTICS, Nanjing (CN)

(72) Inventors: Xiaolong FANG, Nanjing (CN); Di ZHU, Nanjing (CN); Zhao HAN, Nanjing (CN)

(73) Assignee: NANJING UNIVERSITY OF AERONAUTICS AND ASTRONAUTICS, Nanjing (CN)

(21) Appl. No.: 19/296,852

(22) Filed: Aug. 11, 2025

(30) Foreign Application Priority Data
Sep. 3, 2024 (CN) 202411232482.3

(51) Int. Cl. B23H 7/08; B23H 3/02

(52) U.S. Cl. CPC B23H 7/08; B23H 3/02

(57) ABSTRACT

A method and system for controlling machining accuracy of wire electrochemical trimming for a complex profile are provided. The method includes: obtaining a cross-sectional profile of a sample to be trimmed by wire electrochemical trimming; decomposing a cross-sectional profile of the sample to be trimmed by wire electrochemical trimming into straight line segments, convex arc segments, and concave arc segments; determining a mathematical relationship between a material removal depth and machining parameters during wire electrochemical trimming at each segment; substituting an arc curvature radius and a wire electrode radius that are obtained, as well as an average current density value and a wire electrode scan speed that are collected from experimental records or calculated through electric field simulation into the mathematical relationship, calculating a wire electrode scan speed for the concave arc segment and a wire electrode scan speed for the convex arc segment; performing wire electrochemical trimming.

### CROSS REFERENCE TO RELATED APPLICATION

This patent application claims the benefit and priority of Chinese Patent Application No. 2024112324823, filed with the China National Intellectual Property Administration on Sep. 3, 2024, the disclosure of which is incorporated by reference herein in its entirety as part of the present application.

### TECHNICAL FIELD

The present disclosure relates to the technical field of electrochemical machining, and in particular, to a method and system for controlling machining accuracy of wire electrochemical trimming for a complex profile.

### BACKGROUND

Non-traditional machining is an important supplement to slot milling, mainly including wire electrical discharge machining and wire electrochemical machining. Both wire electrical discharge machining and wire electrochemical machining use metal wires for machining, eliminating the need for specially made cathode tools, significantly reducing tool costs. The advantage of wire electrical discharge machining lies in its high efficiency. However, the processed surface has a recast layer and short fatigue life. The advantage of wire electrochemical machining is that the cathode tool experiences no wear, and the processed surface has no recast layer or residual stress. The machining mode of rough slotting of wire electrical discharge machining followed by wire electrochemical trimming can achieve cost-effective and efficient machining of turbine disk slots. Wire electrical discharge machining is first used to create a rough profile of a slot efficiently, and then wire electrochemical machining, which can achieve good surface quality, is used to finish the profile surface, meeting the surface quality requirements for slot machining.

However, controlling machining accuracy of wire electrochemical trimming is a challenge. A machining gap is present between the anode and cathode in wire electrochemical machining. A neutral salt solution conducts the wire electrode and the anode workpiece, and under the action of the electric field, the anode material undergoes electrochemical dissolution within the gap. The amount of anode material removed is proportional to the electric charge according to Faraday's law. The full profile of a turbine disk slot can be geometrically decomposed into straight line segments and arc segments. During wire electrochemical trimming of the turbine disk slot, when the wire electrode sweeps uniformly across these different positions, the distribution of integral electric charge on the workpiece surface varies, resulting in significant differences in the material removal depths of the arc segments with different curvature radii compared to the material removal depth of the straight segments, negatively impacting the profile accuracy of the processed workpiece. To make the full profile accuracy of the turbine disk slot meet the manufacturing requirements of the set standards, there is an urgent need to propose a method for controlling machining accuracy of wire electrochemical machining for a complex profile to ensure consistent material removal depths during the finishing of the turbine disk slot, achieving high-accuracy machining.

### SUMMARY

An objective of the present disclosure is to provide a method and system for controlling machining accuracy of wire electrochemical trimming for a complex profile, which can solve the problem of uncontrollable accuracy in existing wire electrochemical trimming for complex profiles, thereby improving the machining profile accuracy of the parts.

To achieve the above objective, the present disclosure provides the following solutions:

According to a first aspect, the present disclosure provides a method for controlling machining accuracy of wire electrochemical trimming for a complex profile, including:
obtaining a cross-sectional profile of a sample to be trimmed by wire electrochemical trimming;
geometrically decomposing the cross-sectional profile into straight line segments, convex arc segments, and concave arc segments;
determining, according to Faraday's law, a mathematical relationship between a material removal depth and machining parameters during wire electrochemical trimming at the concave arc segment, the convex arc segment, and the straight line segment, where the machining parameters include an arc curvature radius, a wire electrode radius, an average current density value, and a wire electrode scan speed;
substituting an arc curvature radius and a wire electrode radius that are obtained, as well as an average current density value and a wire electrode scan speed that are collected from experimental records or calculated through electric field simulation into the mathematical relationship, and calculating a wire electrode scan speed for the concave arc segment and a wire electrode scan speed for the convex arc segment by using a wire electrode scan speed for the straight line segment as a standard, where the wire electrode scan speed for the concave arc segment is a speed that makes a material removal depth of the concave arc segment equal to a material removal depth of the straight line segment, and the wire electrode scan speed for the convex arc segment is a speed that makes a material removal depth of the convex arc segment equal to the material removal depth of the straight line segment; and
performing wire electrochemical trimming on a profile to be trimmed by wire electrochemical trimming by using a tool wire electrode based on the calculated wire electrode scan speed for the concave arc segment, the calculated wire electrode scan speed for the convex arc segment, and the wire electrode scan speed for the straight line segment.

According to a second aspect, the present disclosure provides a system for controlling machining accuracy of wire electrochemical trimming for a complex profile, including:
a parameter obtaining module configured to obtain a cross-sectional profile of a sample to be trimmed by wire electrochemical trimming;
a decomposition module configured to geometrically decompose the cross-sectional profile into straight line segments, convex arc segments, and concave arc segments;
a first calculation module configured to determine, according to Faraday's law, a mathematical relationship between a material removal depth and machining parameters during wire electrochemical trimming at the concave arc segment, the convex arc segment, and the straight line segment, where the machining parameters include an arc curvature radius, a wire electrode radius, an average current density value, and a wire electrode scan speed;
a second calculation module configured to substitute an arc curvature radius and a wire electrode radius that are obtained, as well as an average current density value and a wire electrode scan speed that are collected from experimental records or calculated through electric field simulation into the mathematical relationship, and calculate a wire electrode scan speed for the concave arc segment and a wire electrode scan speed for the convex arc segment by using a wire electrode scan speed for the straight line segment as a standard, where the wire electrode scan speed for the concave arc segment is a speed that makes a material removal depth of the concave arc segment equal to a material removal depth of the straight line segment, and the wire electrode scan speed for the convex arc segment is a speed that makes a material removal depth of the convex arc segment equal to the material removal depth of the straight line segment; and
a machining module configured to perform wire electrochemical trimming on a profile to be trimmed by wire electrochemical trimming by using a tool wire electrode based on the calculated wire electrode scan speed for the concave arc segment, the calculated wire electrode scan speed for the convex arc segment, and the wire electrode scan speed for the straight line segment.

According to specific examples provided in this application, this application discloses the following technical effects:

The present disclosure provides a method and system for controlling machining accuracy of wire electrochemical trimming for a complex profile. In this method, an obtained cross-sectional profile of a sample to be trimmed by wire electrochemical trimming is decomposed into straight line segments, convex arc segments, and concave arc segments, allowing for targeted control of each segment. According to Faraday's law, a mathematical relationship between a material removal depth and machining parameters during wire electrochemical trimming at the concave arc segment, convex arc segment, straight line segment is determined. Then, an arc curvature radius and a wire electrode radius that are obtained, as well as an average current density value and a wire electrode scan speed that are collected from experimental records or calculated through electric field simulation are substituted into the mathematical relationship, and a wire electrode scan speed for the concave arc segment and a wire electrode scan speed for the convex arc segment are calculated by using a wire electrode scan speed for the straight line segment as a standard. After the speeds for all the segments are calculated, different wire electrode scan speeds can be used for machining different segments of a profile to be trimmed by wire electrochemical trimming, ensuring that the integral electric charge at each feature position of a complex-profile part is equal in wire electrochemical trimming, resulting in a consistent material removal depth across the entire profile of the part.

### BRIEF DESCRIPTION OF THE DRAWINGS

To describe the technical solutions in the embodiments of the present disclosure or in the prior art more clearly, the following briefly describes the accompanying drawings required for the embodiments. Apparently, the accompanying drawings in the following description show merely some embodiments of the present disclosure, and a person of ordinary skill in the art may still derive other accompanying drawings from these accompanying drawings without creative efforts.

FIG. 1 is a schematic flowchart of a method for controlling machining accuracy of wire electrochemical trimming for a complex profile according to an embodiment of the present disclosure;

FIG. 2 illustrates an example model of an anode workpiece in the method for controlling machining accuracy of wire electrochemical trimming for a complex profile according to an embodiment of the present disclosure;

FIG. 3A, FIG. 3B and FIG. 3C are schematic diagrams of geometric models of a straight line segment and arc segments in the method for controlling machining accuracy of wire electrochemical trimming for a complex profile according to an embodiment of the present disclosure;

FIG. 4A and FIG. 4B are simulation diagrams of material removal profiles during wire electrochemical trimming with and without the method for controlling machining accuracy of wire electrochemical trimming for a complex profile according to an embodiment of the present disclosure;

FIG. 5 is a schematic diagram of wire electrochemical trimming in the method for controlling machining accuracy of wire electrochemical trimming for a complex profile according to an embodiment of the present disclosure;

FIG. 6A illustrates a profile error test result of wire electrochemical trimming without the method for controlling machining accuracy of wire electrochemical trimming for a complex profile according to an embodiment of the present disclosure; FIG. 6B illustrates a profile error test result of wire electrochemical trimming with the method for controlling machining accuracy of wire electrochemical trimming for a complex profile according to an embodiment of the present disclosure; and

FIG. 7 is a structural diagram of a system for controlling machining accuracy of wire electrochemical trimming for a complex profile according to an embodiment of the present disclosure.

Reference numerals: convex arc segment-1, straight line segment-2, concave arc segment-3, rotary motor-4, wire electrode-5, workpiece-6, guider-7, DC power supply-8, electrolyte domain-9.

### DETAILED DESCRIPTION OF THE EMBODIMENTS

The technical solutions in the embodiments of the present disclosure are clearly and completely described below with reference to the drawings in the embodiments of the present disclosure. Apparently, the described embodiments are only some rather than all of the embodiments of the present disclosure. All other embodiments obtained by a person of ordinary skill in the art based on the embodiments of the present disclosure without creative efforts shall fall within the protection scope of the present disclosure.

To make the above objectives, features, and advantages of the present disclosure more obvious and easy to understand, the present disclosure will be further described in detail with reference to the accompanying drawings and specific implementations.

### Embodiment 1

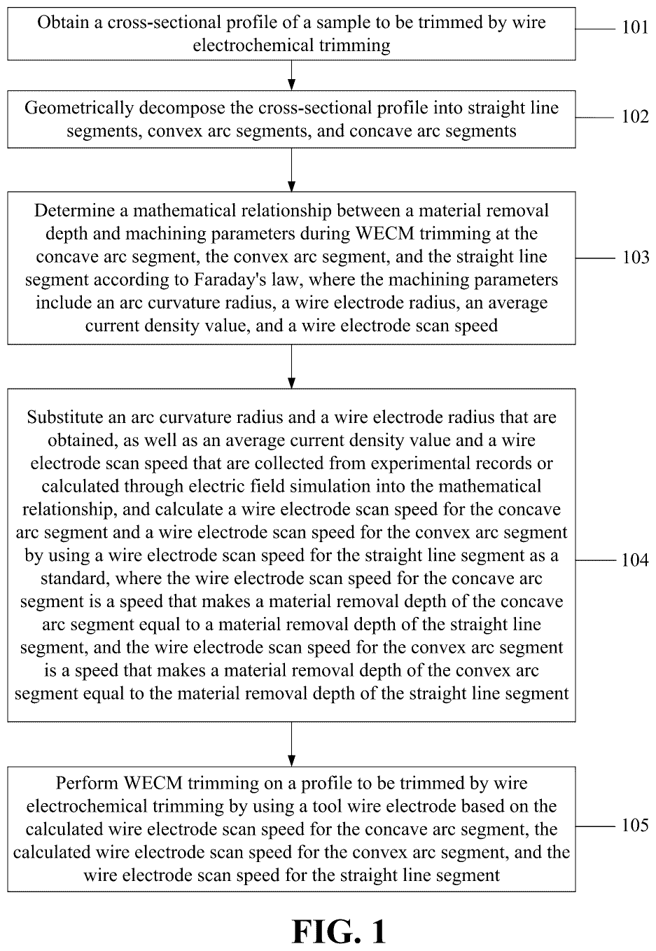

As shown in FIG. 1, this embodiment provides a method for controlling machining accuracy of wire electrochemical trimming for a complex profile, including the following steps:

Step 101: Obtain a cross-sectional profile of a sample to be trimmed by wire electrochemical trimming.

Step 102: Geometrically decompose the cross-sectional profile into straight line segments 2, convex arc segments 1, and concave arc segments 3.

Step 103: Determine a mathematical relationship between a material removal depth and machining parameters during wire electrochemical trimming at the concave arc segment 3, the convex arc segment 1, and the straight line segment 2 according to Faraday's law, where the machining parameters include an arc curvature radius, a wire electrode radius, an average current density value, and a wire electrode scan speed.

Step 104: Substitute an arc curvature radius and a wire electrode radius that are obtained, as well as an average current density value and a wire electrode scan speed that are collected from experimental records or calculated through electric field simulation into the mathematical relationship, and calculate a wire electrode scan speed for the concave arc segment 3 and a wire electrode scan speed for the convex arc segment 1 by using a wire electrode scan speed for the straight line segment 2 as a standard, where the wire electrode scan speed for the concave arc segment 3 is a speed that makes a material removal depth of the concave arc segment 3 equal to a material removal depth of the straight line segment 2, and the wire electrode scan speed for the convex arc segment 1 is a speed that makes a material removal depth of the convex arc segment 1 equal to the material removal depth of the straight line segment 2.

Step 105: Perform wire electrochemical trimming on a profile to be trimmed by wire electrochemical trimming by using a tool wire electrode based on the calculated wire electrode scan speed for the concave arc segment 3, the calculated wire electrode scan speed for the convex arc segment 1, and the wire electrode scan speed for the straight line segment 2.

In some embodiments, during execution of step 101:

The profile to be trimmed by wire electrochemical trimming is a profile obtained after rough machining with wire electrical discharge machining, that is, the profile obtained from rough machining with wire electrical discharge machining is set as the profile to be trimmed by wire electrochemical trimming.

In some embodiments, steps 102 to 103 may be specifically as follows:

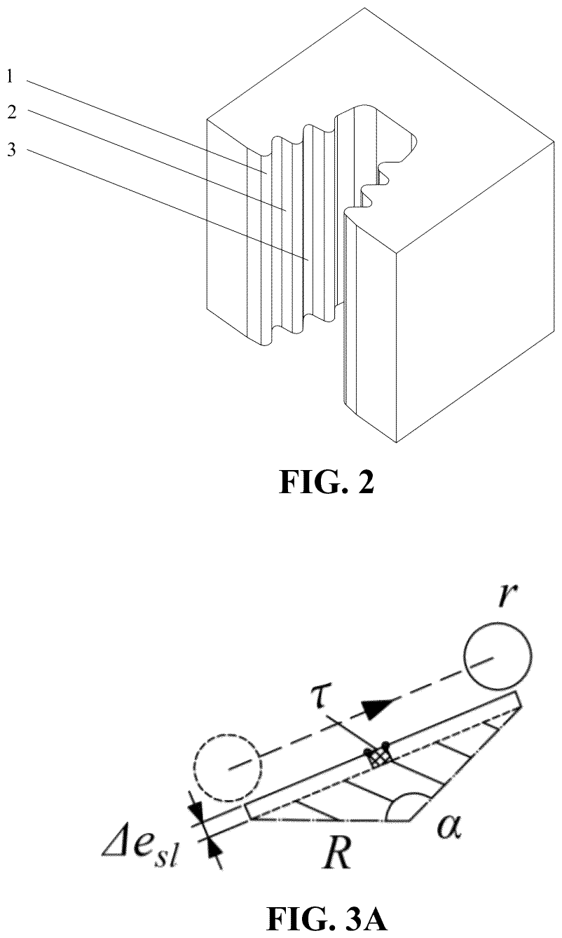

As shown in FIG. 2, taking a fir-tree slot of an engine turbine disk as an example, a to-be-machined complex profile of a workpiece 6 can be decomposed into: convex arc segments 1, straight line segments 2, and concave arc segments 3.

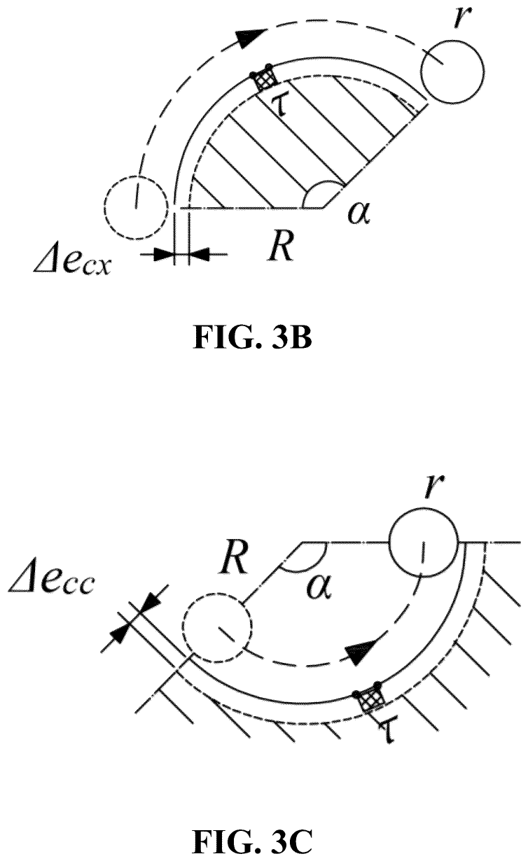

In geometric models of the straight line segment 2 and arc segments in the method for controlling machining accuracy of wire electrochemical trimming for a complex profile shown in FIG. 3A, FIG. 3B and FIG. 3C, FIG. 3A shows a geometric model of the straight line segment, FIG. 3B shows a geometric model of the convex arc segment 1, and FIG. 3C shows a geometric model of the concave arc segment 3. The relationship between the material removal depth and the wire electrode scan speed for the straight line segment 2, the convex arc segment 1, and the concave arc segment 3 in wire electrochemical trimming is studied based on the geometric models. Through mathematical derivation, the material removal depth per unit arc length is calculated. According to Faraday's law, material removal volumes V for the straight line, convex arc, and concave arc are respectively:

$$\{ \begin{matrix}{V}_{s l} & = ω \cdot τ \cdot H \cdot {\overline{i}}_{s l} \cdot {t}_{s l} \\ & = ω \cdot τ \cdot H \cdot {\overline{i}}_{s l} \cdot 2 R \cdot sin ( α / 2 ) / {v}_{{f}_{sl}} \\ & \approx ω \cdot τ \cdot H \cdot {\overline{i}}_{s l} \cdot α \cdot R / {v}_{{f}_{sl}} \\ {V}_{c x} & = ω \cdot τ \cdot H \cdot {\overline{i}}_{c x} \cdot {t}_{c x} = ω \cdot τ \cdot H \cdot {\overline{i}}_{c x} \cdot α ( R + r ) / {v}_{{f}_{cx}} \\ {V}_{c c} & = ω \cdot τ \cdot H \cdot {\overline{i}}_{c c} \cdot {t}_{c c} = ω \cdot τ \cdot H \cdot {\overline{i}}_{c c} \cdot α ( R − r ) / {v}_{{f}_{cc}}\end{matrix} . \qquad ( 1 )$$

ω represents an electrochemical volume equivalent, τ represents a unit vector in a trajectory direction, H represents a thickness of a part, l̅ represents an average current density, t represents a machining time, α and R represents a corner radius and an arc radius respectively, and r represents a wire electrode radius. The subscript sl indicates straight line, cc indicates concave arc, and cx indicates convex arc.

Based on geometric shape calculations, the material removal volumes V for the straight line, convex arc, and concave arc are also equal to:

$$\{ \begin{matrix}{V}_{s l} = τ \cdot H \cdot Δ {e}_{s l} \\ {V}_{c x} = τ \cdot H \cdot Δ {e}_{c x} \\ {V}_{cc} = τ \cdot H \cdot Δ {e}_{c c}\end{matrix} . \qquad ( 2 )$$

From equations (1) and (2), the material removal depths for the straight line segment, convex arc segment, and concave arc segment are respectively:

$$\{ \begin{matrix}Δ {e}_{s l} = \frac{ω \cdot α \cdot R \cdot {\overline{i}}_{s l}}{{v}_{{f}_{sl}}} \\ Δ {e}_{c x} = \frac{ω \cdot α ( R + r ) \cdot {\overline{i}}_{c x}}{{v}_{{f}_{cx}}} \\ Δ {e}_{c c} = \frac{ω \cdot α ( R − r ) \cdot {\overline{i}}_{c c}}{{v}_{{f}_{cc}}}\end{matrix} . \qquad ( 3 )$$

From equation (3), it can be seen that the material removal depth Δe is proportional to the average current density l̅, positively correlated with the machining arc radius R, and inversely proportional to the wire electrode scan speed v_{f}. Additionally, the material removal depth Δe_{cx} for the convex arc is positively correlated with the wire electrode radius r, while the material removal depth Δe_{cc} for the concave arc is negatively correlated with the wire electrode radius r. During execution of step 104, using the wire electrode scan speed v_{f}_{ₛₗ} for the straight line segment 2 as the standard, to achieve uniform material removal, the wire electrode scan speeds for the convex arc and concave arc should be set as:

$$\begin{matrix} & {v}_{{f}_{c x}} = {v}_{{f}_{s l}} \cdot \frac{{\overline{i}}_{c x}}{{\overline{i}}_{s l}} \cdot ( 1 + \frac{r}{R} )\end{matrix} . \qquad ( 4 )$$

$${v}_{{f}_{c c}} = {v}_{{f}_{s l}} \cdot \frac{{\overline{i}}_{c c}}{{\overline{i}}_{s l}} \cdot ( 1 − \frac{r}{R} ) . \qquad ( 5 )$$

Δeₛₗ represents the material removal depth for the straight line segment 2, Δe_{cx} represents the material removal depth for the convex arc segment 1, Δe_{cc} represents the material removal depth for the concave arc segment 3, ω represents an electrochemical volume equivalent, α and R represent a corner radius and an arc radius respectively, īₛₗ represents an average current density for the straight line segment 2, ī_{cx} represents an average current density for the convex arc segment 1, ī_{cc} represents an average current density for the concave arc segment 3, r represents the wire electrode radius, v_{f}_{ₛₗ} represents the wire electrode scan speed for the straight line segment 2, v_{f}_{_{cx}} represents the wire electrode scan speed for the convex arc segment 1, and v_{f}_{_{cc}} represents the wire electrode scan speed for the concave arc segment 3.

Step 105 may specifically include:

compiling the calculated wire electrode scan speed for the concave arc segment 3, the calculated wire electrode scan speed for the convex arc segment 1, and the wire electrode scan speed for the straight line segment 2 into G-code instructions for a complex profile machining trajectory, to obtain a machining program compiled with a machining accuracy control method.

The workpiece 6 is connected to a positive terminal of a DC power supply 8, and the tool wire electrode (metal wire with a diameter of 0.5-1 mm) is connected to a negative terminal of the DC power supply 8. At the same time, the wire electrode 5 rotates around its axis at a preset speed (1,000-10,000 rpm). The workpiece 6 and the tool electrode are immersed in the electrolyte, and the machining program compiled with the machining accuracy control method is introduced. The power supply is turned on, and the wire electrode 5 scans along the complex part profile according to a preset trajectory and a preset control speed, performing wire electrochemical trimming. After machining, the material removal depths of different characteristic profile segments are measured.

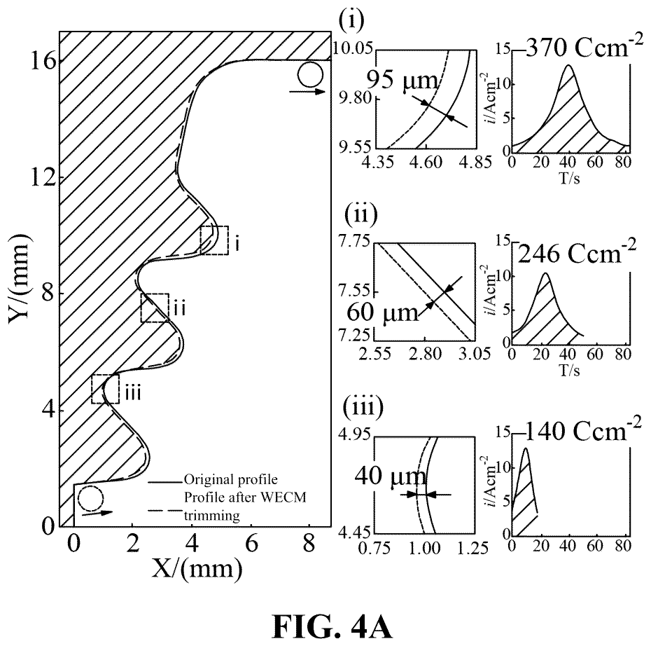

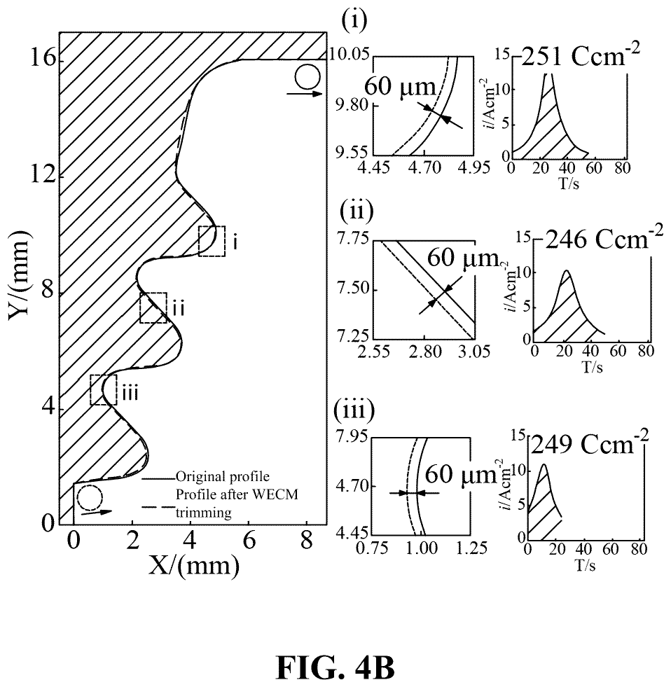

Specifically, as shown in FIG. 4A and FIG. 4B, FIG. 4A is a simulation diagram of a material removal profile during wire electrochemical trimming with the method for controlling machining accuracy of wire electrochemical trimming for a complex profile, and FIG. 4B is a simulation diagram of a material removal profile during wire electrochemical trimming without the method for controlling machining accuracy of wire electrochemical trimming for a complex profile. Simulation parameters for the case are shown in Table 1. When dynamic speed adjustment is not performed in wire electrochemical trimming, charge distributions for the convex arc segment 1, the straight line segment 2, and the concave arc segment 3 are different, leading to unequal material removal depths. After dynamic speed adjustment is performed in wire electrochemical trimming, the charge distributions for the convex arc segment 1, the straight line segment 2, and the concave arc segment 3 become equal, resulting in equal material removal depths.

TABLE 1
Simulation Parameters

| Parameter | Value | |
|---|---|---|
| Wire electrode radius (r) | 0.5 | mm |
| Radius of the convex arc and concave arc on the | 0.8 | mm |
| workpiece (R) | | |
| Voltage (U) | 14 | V |
| Actual electrochemical volume equivalent (ηω) | 2.050[mm³/(A · min) | |
| Wire electrode scan speed (v_{f}) | 3 | mm/min |

| | |
|---|---|
| Electrolyte conductivity (σ₀) | (0.33 mS/cm) |

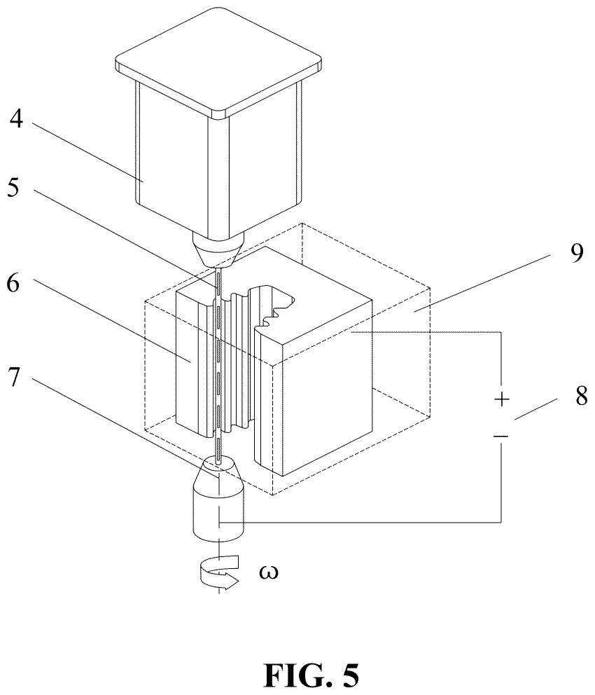

The specific machining schematic diagram is shown in FIG. 5, which includes: a rotary motor 4, a wire electrode 5, a workpiece 6, a guider 7, a DC power supply 8, and an electrolyte domain 9. The wire electrode 5 is mounted on the rotary motor 4 via the guider 7; the wire electrode 5 is connected to the negative terminal of the DC power supply 8, and the workpiece 6 is connected to the positive terminal of the DC power supply 8. The workpiece 6 and the wire electrode 5 are immersed in the electrolyte domain 9. The power supply is turned on, and the wire electrode 5 feeds along the profile of the workpiece 6 according to preset motion trajectory and scan speed.

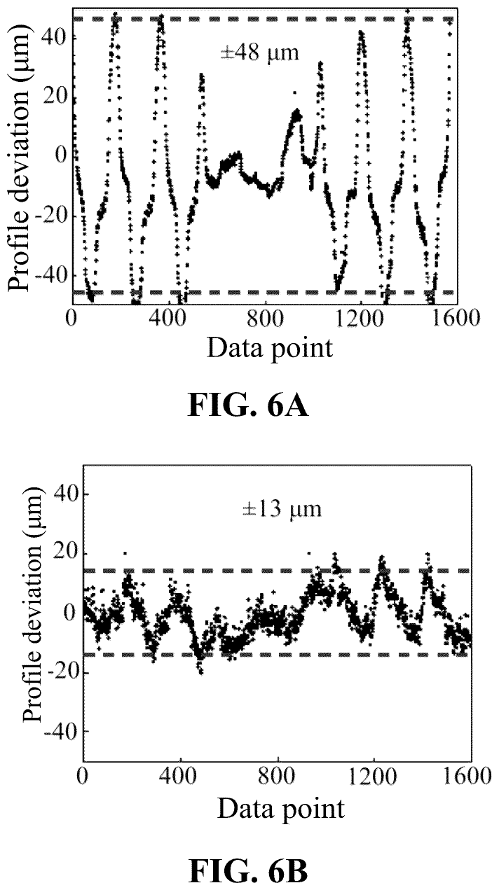

Profile error test results of wire electrochemical trimming with and without the method for machining accuracy of wire electrochemical trimming for a complex profile are shown in FIG. 6A and FIG. 6B, where FIG. 6A shows the profile error test result without using the method for machining accuracy of wire electrochemical trimming for a complex profile, and FIG. 6B shows the profile error test result using the method for machining accuracy of wire electrochemical trimming for a complex profile. It can be seen that, compared to FIG. 6A, the profile errors after using this method are significantly smaller. Test parameters for the case are shown in Table 2. The profile error of the complex part profile after wire electrochemical trimming is measured. When dynamic speed adjustment is not performed during wire electrochemical trimming, the profile errors for the convex arc segment 1 and the concave arc segment 3 are significantly higher than that of the straight line segment 2, with a total profile error of ±50 μm. After dynamic speed adjustment is performed during wire electrochemical trimming, the profile errors for the convex arc segment 1 and the concave arc segment 3 are significantly reduced, with a total profile error of +18 μm.

TABLE 2
Test Parameters

| Parameter | Value | |
|---|---|---|
| Wire electrode radius (r) | 304SS with a radius of 0.5 mm | |
| Rotational speed | 1000 | rpm |
| Workpiece thickness (H) | 30 | mm |
| Voltage amplitude (U) | 40 | V |
| Duty cycle (D) | 35% | |
| Frequency (f) | 20 | kHz |
| Wire electrode scan speed (vf) | 3 | mm/min |

| | |
|---|---|
| Electrolyte | 1 mol/L NaCl - ethylene glycol solution |

### Embodiment 2

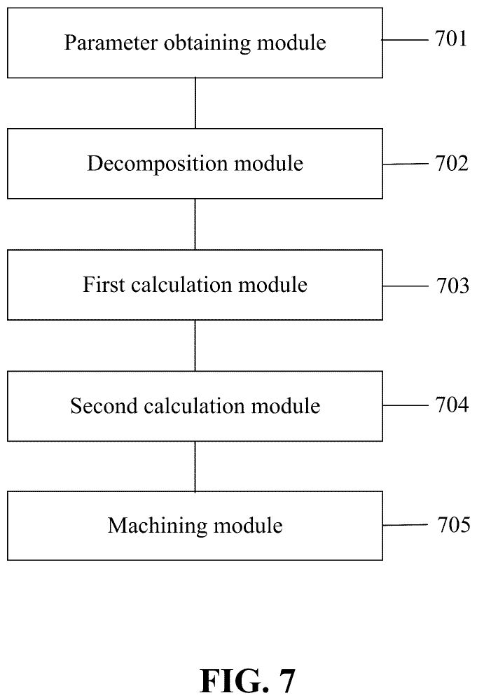

As shown in FIG. 7, this embodiment provides a system for controlling machining accuracy of wire electrochemical trimming for a complex profile, including:
a parameter obtaining module 701 configured to obtain a cross-sectional profile of a sample to be trimmed by wire electrochemical trimming;
a decomposition module 702 configured to geometrically decompose the cross-sectional profile into straight line segments 2, convex arc segments 1, and concave arc segments 3;
a first calculation module 703 configured to determine, according to Faraday's law, a mathematical relationship between a material removal depth and machining parameters during wire electrochemical trimming at the concave arc segment 3, the convex arc segment 1, and the straight line segment 2, where the machining parameters include an arc curvature radius, a wire electrode radius, an average current density value, and a wire electrode scan speed;
a second calculation module 704 configured to substitute an arc curvature radius and a wire electrode radius that are obtained, as well as an average current density value and a wire electrode scan speed that are collected from experimental records or calculated through electric field simulation into the mathematical relationship, and calculate a wire electrode scan speed for the concave arc segment 3 and a wire electrode scan speed for the convex arc segment 1 by using a wire electrode scan speed for the straight line segment 2 as a standard, where the wire electrode scan speed for the concave arc segment 3 is a speed that makes a material removal depth of the concave arc segment 3 equal to a material removal depth of the straight line segment 2, and the wire electrode scan speed for the convex arc segment 1 is a speed that makes a material removal depth of the convex arc segment 1 equal to the material removal depth of the straight line segment 2; and
a machining module 705 configured to perform wire electrochemical trimming on a profile to be trimmed by wire electrochemical trimming by using a tool wire electrode based on the calculated wire electrode scan speed for the concave arc segment 3, the calculated wire electrode scan speed for the convex arc segment 1, and the wire electrode scan speed for the straight line segment 2.

The machining module 705 includes:
a program compiling submodule configured to compile the calculated wire electrode scan speed for the concave arc segment 3, the calculated wire electrode scan speed for the convex arc segment 1, and the wire electrode scan speed for the straight line segment 2 into G-code instructions for a complex profile machining trajectory, to obtain a machining program compiled with a machining accuracy control method; and
a machining submodule configured to enable the tool wire electrode that has been powered on to scan along a complex part profile according to a preset trajectory and a preset control speed based on the machining program compiled with the machining accuracy control method, to perform wire electrochemical trimming.

In summary, the present disclosure has the following technical effects:

The present disclosure ensures that during the machining, whether for the straight line segment 2, convex arc segment 1, or concave arc segment 3, the average current density at each feature position remains consistent by dynamically adjusting the scan speed of the wire electrode 5. This guarantees uniform material removal depths across the overall profile of the part, achieving high-accuracy profile machining.

The method in the present disclosure utilizes mathematical formulas related to arc curvature radius, wire electrode radius, and average current density to accurately calculate the required wire electrode scan speeds for different feature positions. Moreover, the method is seamlessly integrated into the machine tool system through CNC programming, enabling online dynamic adjustments during the machining without interrupting operations, thereby significantly enhancing machining efficiency and precision.

The technical features of the above embodiments can be employed in arbitrary combinations. To provide a concise description of these embodiments, all possible combinations of all the technical features of the above embodiments may not be described; however, these combinations of the technical features should be construed as falling within the scope defined by the specification as long as no contradiction occurs.

Several examples are used herein for illustration of the principles and implementations of this application. The description of the foregoing examples is used to help illustrate the method of this application and the core principles thereof. In addition, those of ordinary skill in the art can make various modifications in terms of specific implementations and scope of application in accordance with the teachings of this application. In conclusion, the content of the present specification shall not be construed as a limitation to this application.

1. A method for controlling machining accuracy of wire electrochemical trimming for a complex profile, comprising:
obtaining a cross-sectional profile of a sample to be trimmed by wire electrochemical trimming;
geometrically decomposing the cross-sectional profile into straight line segments, convex arc segments, and concave arc segments;
determining, according to Faraday's law, a mathematical relationship between a material removal depth and machining parameters during wire electrochemical trimming at the concave arc segment, the convex arc segment, and the straight line segment, wherein the machining parameters comprise an arc curvature radius, a wire electrode radius, an average current density value, and a wire electrode scan speed;
substituting an arc curvature radius and a wire electrode radius that are obtained, as well as an average current density value and a wire electrode scan speed that are collected from experimental records or calculated through electric field simulation into the mathematical relationship, and calculating a wire electrode scan speed for the concave arc segment and a wire electrode scan speed for the convex arc segment by using a wire electrode scan speed for the straight line segment as a standard, wherein the wire electrode scan speed for the concave arc segment is a speed that makes a material removal depth of the concave arc segment equal to a material removal depth of the straight line segment, and the wire electrode scan speed for the convex arc segment is a speed that makes a material removal depth of the convex arc segment equal to the material removal depth of the straight line segment; and
performing wire electrochemical trimming on a profile to be trimmed by wire electrochemical trimming by using a tool wire electrode based on the calculated wire electrode scan speed for the concave arc segment, the calculated wire electrode scan speed for the convex arc segment, and the wire electrode scan speed for the straight line segment.

2. The method for controlling machining accuracy of wire electrochemical trimming for a complex profile according to claim 1, wherein the profile to be trimmed by wire electrochemical trimming is profile obtained after rough machining with wire electrical discharge machining.

3. The method for controlling machining accuracy of wire electrochemical trimming for a complex profile according to claim 1, wherein the mathematical relationship between the material removal depth and the machining parameters during wire electrochemical trimming at the concave arc segment, the convex arc segment, and the straight line segment is specifically as follows:
$$\{ \begin{matrix}Δ {e}_{s l} = \frac{ω \cdot α \cdot R \cdot {\overline{i}}_{s l}}{{v}_{{f}_{sl}}} \\ Δ {e}_{c x} = \frac{ω \cdot α ( R + r ) \cdot {\overline{i}}_{c x}}{{v}_{{f}_{cx}}} \\ Δ {e}_{c c} = \frac{ω \cdot α ( R − r ) \cdot {\overline{i}}_{c c}}{{v}_{{f}_{cc}}}\end{matrix} ;$$
wherein Δeₛₗ represents the material removal depth for the straight line segment, Δe_{cx} represents the material removal depth for the convex arc segment, Δe_{cc} represents the material removal depth for the concave arc segment, @ represents an electrochemical volume equivalent, α and R represent a corner radius and an arc radius respectively, īₛₗ represents an average current density for the straight line segment, ī_{cx} represents an average current density for the convex arc segment, ī_{cc} represents an average current density for the concave arc segment, r represents the wire electrode radius, v_{f}_{ₛₗ} represents the wire electrode scan speed for the straight line segment, v_{f}_{_{cx}} represents the wire electrode scan speed for the convex arc segment, and v_{f}_{_{cc}} represents the wire electrode scan speed for the concave arc segment.

4. The method for controlling machining accuracy of wire electrochemical trimming for a complex profile according to claim 1, wherein the substituting the arc curvature radius and the wire electrode radius that are obtained, as well as the average current density value and the wire electrode scan speed that are collected from experimental records or calculated through electric field simulation into the mathematical relationship, and calculating the wire electrode scan speed for the concave arc segment and the wire electrode scan speed for the convex arc segment by using the wire electrode scan speed for the straight line segment as the standard specifically comprises:
calculating the wire electrode scan speed for the convex arc segment according to the following formula:
$${ν}_{{f}_{cx}} = {v}_{{f}_{s l}} \cdot \frac{{\overline{i}}_{c x}}{{\overline{i}}_{s l}} \cdot ( 1 + \frac{r}{R} ) ;$$
wherein R represents an arc radius, īₛₗ represents an average current density for the straight line segment, ī_{cx} represents an average current density for the convex arc segment, r represents the wire electrode radius, v_{f}_{ₛₗ} represents the wire electrode scan speed for the straight line segment, and v_{f}_{_{cx}} represents the wire electrode scan speed for the convex arc segment.

5. The method for controlling machining accuracy of wire electrochemical trimming for a complex profile according to claim 1, wherein the substituting the arc curvature radius and the wire electrode radius that are obtained, as well as the average current density value and the wire electrode scan speed that are collected from experimental records or calculated through electric field simulation into the mathematical relationship, and calculating the wire electrode scan speed for the concave arc segment and the wire electrode scan speed for the convex arc segment by using the wire electrode scan speed for the straight line segment as the standard specifically comprises:
calculating the wire electrode scan speed for the concave arc segment according to the following formula:
$${ν}_{{f}_{cc}} = {v}_{{f}_{s l}} \cdot \frac{{\overline{i}}_{cc}}{{\overline{i}}_{s l}} \cdot ( 1 + \frac{r}{R} ) ;$$
wherein R represents an arc radius, īₛₗ represents an average current density for the straight line segment, ī_{cc} represents an average current density for the concave arc segment, r represents the wire electrode radius, v_{f}_{ₛₗ} represents the wire electrode scan speed for the straight line segment, and v_{f}_{_{cc}} represents the wire electrode scan speed for the concave arc segment.

6. The method for controlling machining accuracy of wire electrochemical trimming for a complex profile according to claim 1, wherein the performing wire electrochemical trimming on the profile to be trimmed by wire electrochemical trimming based on the calculated wire electrode scan speed for the concave arc segment, the calculated wire electrode scan speed for the convex arc segment, and the wire electrode scan speed for the straight line segment specifically comprises:
compiling the calculated wire electrode scan speed for the concave arc segment, the calculated wire electrode scan speed for the convex arc segment, and the wire electrode scan speed for the straight line segment into G-code instructions for a complex profile machining trajectory, to obtain a machining program compiled with a machining accuracy control method; and
enabling the tool wire electrode that has been powered on to scan along a complex part profile according to a preset trajectory and a preset control speed based on the machining program compiled with the machining accuracy control method, to perform wire electrochemical trimming.

7. The method for controlling machining accuracy of wire electrochemical trimming for a complex profile according to claim 6, wherein the tool wire electrode rotates along an axis of the tool wire electrode based on a preset rotational speed, and the preset rotational speed is in a range of 1,000-1,0000 rpm.

8. The method for controlling machining accuracy of wire electrochemical trimming for a complex profile according to claim 7, wherein the tool wire electrode is a metal wire with a diameter of 0.5-1 mm.

9. A system for controlling machining accuracy of wire electrochemical trimming for a complex profile, comprising:
a parameter obtaining module configured to obtain a cross-sectional profile of sample to be trimmed by wire electrochemical trimming;
a decomposition module configured to geometrically decompose the cross-sectional profile into straight line segments, convex arc segments, and concave arc segments;
a first calculation module configured to determine, according to Faraday's law, a mathematical relationship between a material removal depth and machining parameters during wire electrochemical trimming at the concave arc segment, the convex arc segment, and the straight line segment, wherein the machining parameters comprise an arc curvature radius, a wire electrode radius, an average current density value, and a wire electrode scan speed;
a second calculation module configured to substitute an arc curvature radius and a wire electrode radius that are obtained, as well as an average current density value and a wire electrode scan speed that are collected from experimental records or calculated through electric field simulation into the mathematical relationship, and calculate a wire electrode scan speed for the concave arc segment and a wire electrode scan speed for the convex arc segment by using a wire electrode scan speed for the straight line segment as a standard, wherein the wire electrode scan speed for the concave arc segment is a speed that makes a material removal depth of the concave arc segment equal to a material removal depth of the straight line segment, and the wire electrode scan speed for the convex arc segment is a speed that makes a material removal depth of the convex arc segment equal to the material removal depth of the straight line segment; and
a machining module configured to perform wire electrochemical trimming on a profile to be trimmed by wire electrochemical trimming by using a tool wire electrode based on the calculated wire electrode scan speed for the concave arc segment, the calculated wire electrode scan speed for the convex arc segment, and the wire electrode scan speed for the straight line segment.

10. The system for controlling machining accuracy of wire electrochemical trimming for a complex profile according to claim 9, wherein the machining module comprises:
a program compiling submodule configured to compile the calculated wire electrode scan speed for the concave arc segment, the calculated wire electrode scan speed for the convex arc segment, and the wire electrode scan speed for the straight line segment into G-code instructions for a complex profile machining trajectory, to obtain a machining program compiled with a machining accuracy control method; and
a machining submodule configured to enable the tool wire electrode that has been powered on to scan along a complex part profile according to a preset trajectory and a preset control speed based on the machining program compiled with the machining accuracy control method, to perform wire electrochemical trimming.
